(19) United States
(12) Patent Application Publication
(10) Pub. No.: US 2026/0018729 A1
(43) Pub. Date: Jan. 15, 2026

(54) VEHICLE

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi (JP)

(21) Appl. No.: 19/213,284

(22) Filed: May 20, 2025

(30) Foreign Application Priority Data
Jul. 10, 2024 (JP) 2024-110852

(51) Int. Cl. H01M 50/249; B60K 1/04; H01M 10/625; H01M 10/658; H01M 50/262

(52) U.S. Cl. CPC H01M 50/249; B60K 1/04; H01M 10/625; H01M 10/658; H01M 50/262; B60K 2001/0438; H01M 2220/20

(57) ABSTRACT

A vehicle includes: a vehicle body including a floor panel and a frame member; an energy storage device, and a plurality of fastening portions. The frame member includes a first member and a second member. The energy storage device includes a first sidewall, a second sidewall, and a front wall. The fastening portions include a plurality of first fastening portions located at the first sidewall and a plurality of second fastening portions located at the second sidewall. The first fastening portion located furthest to the front is located forward of the second fastening portion located furthest to the front. A protruding portion protruding upward is provided at the front wall of the energy storage device. The protruding portion is disposed so as to overlap a portion of the vehicle body in the vertical direction.

### CROSS-REFERENCE TO RELATED APPLICATION

This application claims priority to Japanese Patent Application No. 2024-110852 filed on Jul. 10, 2024, incorporated herein by reference in its entirety.

### BACKGROUND

### 1. Technical Field

The present disclosure relates to vehicles.

### 2. Description of Related Art

Japanese Unexamined Patent Application Publication No. 2020-059359 (JP 2020-059359 A) describes a vehicle in which an energy storage device and an exhaust pipe are disposed adjacent to each other in a width direction of the vehicle below a floor panel. One side of the energy storage device is fixed to a vehicle frame member located between the exhaust pipe and a sidewall of the energy storage device that is located on one side in the width direction as viewed from above. The other side of the energy storage device is fixed to a vehicle frame member located on the other side in the width direction.

### SUMMARY

The exhaust pipe extends in a front-rear direction of the vehicle, and includes, at its front, a portion extending inward in the width direction of the vehicle. The energy storage device is disposed so as not to interfere with the exhaust pipe. Therefore, when the energy storage device has a large size, it may be difficult to provide a fixed portion of the energy storage device in part of the space between the exhaust pipe and the sidewall of the energy storage device on the one side in the width direction. On the other hand, since the exhaust pipe is not disposed on the other side in the width direction, the other side of the energy storage device can be fixed to the vehicle frame member without being restricted by the exhaust pipe.

In the case where there is an area in the width direction where one side of the energy storage device is not fixed while the other side of the energy storage device is fixed, the energy storage device tends to be deformed when a load is applied to the energy storage device.

The present disclosure was made in view of the above issue, and an object of the present disclosure is to provide a vehicle that can reduce deformation of an energy storage device when an external load is applied to the energy storage device.

A vehicle according to a first aspect of the present disclosure includes:
a vehicle body including a floor panel and a frame member;
an energy storage device disposed below the floor panel; and
a plurality of fastening portions that fastens the energy storage device to the frame member. The frame member includes a first member and a second member. The first member and the second member extend in a front-rear direction of the vehicle, and are located spaced apart from each other in a width direction of the vehicle.

The energy storage device includes a first sidewall, a second sidewall, and a front wall. The first sidewall and the second sidewall are located spaced apart from each other in the width direction. The front wall is located at the front of the energy storage device, and connects the first sidewall and the second sidewall.

The fastening portions include a plurality of first fastening portions located at the first sidewall and fixed to the first member, and a plurality of second fastening portions located at the second sidewall and fixed to the second member.

The first fastening portion located furthest to the front out of the first fastening portions is located forward of the second fastening portion located furthest to the front out of the second fastening portions.

A protruding portion protruding upward is provided at the front wall of the energy storage device. The protruding portion is disposed so as to overlap a portion of the vehicle body in a vertical direction.

The first fastening portion located furthest to the front out of the first fastening portions disposed at the first sidewall is typically located forward of the second fastening portion located furthest to the front out of the second fastening portions disposed at the second sidewall. In this case, the energy storage device tends to be deformed upward in the region forward of an imaginary line connecting the first fastening portion located furthest to the front and the second fastening portion located furthest to the front. In the above configuration, however, the protruding portion is provided at the front wall so as to protrude upward, and is disposed so as to overlap a portion of the vehicle body in the vertical direction. Therefore, the protruding portion hits the vehicle body when an upward load is applied to the energy storage device. This reduces upward deformation of the energy storage device in the region forward of the second fastening portion located furthest to the front.

A vehicle according to a second aspect of the present disclosure includes: a vehicle body including a floor panel and a frame member; an energy storage device disposed below the floor panel; and a plurality of fastening portions that fastens the energy storage device to the frame member. The frame member includes a first member and a second member. The first member and the second member extend in a front-rear direction of the vehicle, and are located spaced apart from each other in a width direction of the vehicle. The energy storage device includes a first sidewall, a second sidewall, and a front wall. The first sidewall and the second sidewall are located spaced apart from each other in the width direction. The front wall is located at the front of the energy storage device, and connects the first sidewall and the second sidewall. The fastening portions include a plurality of first fastening portions located at the first sidewall and fixed to the first member, and a plurality of second fastening portions located at the second sidewall and fixed to the second member. The first fastening portion located furthest to the front out of the first fastening portions is located forward of the second fastening portion located furthest to the front out of the second fastening portions. The energy storage device further includes a fixed portion provided with at least the first fastening portion located furthest to the front out of the fastening portions. A protruding portion protruding outward in the width direction is provided at the front wall of the energy storage device. The fixed portion extends in the front-rear direction and includes a portion overlapping the protruding portion in the width direction.

The first fastening portion located furthest to the front out of the first fastening portions disposed at the first sidewall is typically located forward of the second fastening portion located furthest to the front out of the second fastening portions disposed at the second sidewall. The energy storage device therefore tends to be deformed in the width direction in the region forward the second fastening portion located furthest to the front. In the above configuration, however, the protruding portion is provided at the front wall so as to protrude outward in the width direction, and is disposed so as to overlap a portion of the fixed portion in the width direction. Therefore, the fixed portion hits the protruding portion when a load is applied from the fixed portion side toward the second sidewall. This reduces deformation of the energy storage device in the width direction in the region forward of the second fastening portion located furthest to the front.

A vehicle according to a third aspect of the present disclosure includes: a vehicle body including a floor panel and a frame member; an energy storage device disposed below the floor panel; and a plurality of fastening portions that fastens the energy storage device to the frame member. The frame member includes a first member and a second member. The first member and the second member extend in a front-rear direction of the vehicle, and are located spaced apart from each other in a width direction of the vehicle. The energy storage device includes a first sidewall, a second sidewall, and a front wall. The first sidewall and the second sidewall are located spaced apart from each other in the width direction. The front wall is located at the front of the energy storage device, and connects the first sidewall and the second sidewall. The fastening portions include a plurality of first fastening portions located at the first sidewall and fixed to the first member, and a plurality of second fastening portions located at the second sidewall and fixed to the second member. The first fastening portion located furthest to the front out of the first fastening portions is located forward of the second fastening portion located furthest to the front out of the second fastening portions. The vehicle further includes: an exhaust pipe disposed along the second sidewall; and a heater insulator disposed between the exhaust pipe and the second sidewall. A protruding portion is provided at the front wall of the energy storage device. The protruding portion extends between the second sidewall and the heater insulator. The protruding portion is configured to reduce the flow of gas from a distal end side of the heater insulator into a space between the second sidewall and the heater insulator.

With the above configuration, the protruding portion reduces the flow of gas from the distal end side of the heater insulator into the space between the second sidewall and the heater insulator. This reduces entry of hot gas heated by the exhaust pipe into the space between the second sidewall and the heater insulator, and thus, reduces an increase in temperature inside the energy storage device through the second sidewall.

In the vehicle according to the first to third aspects of the present disclosure, the energy storage device may include a connector block provided on the front wall. The connector block may be a single-piece component made of the same material. The protruding portion may be part of the connector block.

In the above configuration, the protruding portion is part of the connector block. This allows the protruding portion to have enough rigidity, reduces the number of components, and also reduces upward deformation of the energy storage device.

In the vehicle according to the first to third aspects of the present disclosure, the protruding portion may be provided with a rib.

In the above configuration, the protruding portion is provided with the rib. This increases rigidity of the protruding portion.

The vehicle according to the first aspect of the present disclosure may further include a cushioning member disposed between the portion of the vehicle body and the protruding portion.

With the above configuration, the cushioning member reduces transmission of vibration to the vehicle body.

The present disclosure can provide a vehicle that can reduce deformation of an energy storage device when an external load is applied to the energy storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view illustrating an energy storage device fixed to a vehicle frame member in a state adjacent to an exhaust pipe in a width direction of a vehicle in a vehicle according to a first embodiment;

FIG. 2 is a side view of an energy storage device disposed below a floor panel in the vehicle according to the first embodiment;

FIG. 3 is a plan view illustrating a position of a protruding portion in the vehicle according to a first embodiment;

FIG. 4 is a plan view illustrating an energy storage device fixed to a vehicle frame member in a state adjacent to an exhaust pipe in a width direction of the vehicle in the vehicle according to a second embodiment;

FIG. 5 is an enlarged view illustrating a structure around a third member in the vehicle according to the second embodiment;

FIG. 6 is a plan view illustrating an energy storage device fixed to a vehicle frame member in a state adjacent to an exhaust pipe in a width direction of the vehicle in the vehicle according to a third embodiment;

FIG. 7 is an enlarged view illustrating a structure around a protruding portion of a connector block in the vehicle according to the third embodiment;

FIG. 8 is an enlarged plan view illustrating a structure around a connector block in the vehicle according to a fourth embodiment;

FIG. 9 is a perspective view illustrating a structure around a connector block in the vehicle according to the fourth embodiment;

FIG. 10 is a cross-sectional view taken along X-X shown in FIG. 9; and

FIG. 11 is a perspective view illustrating a structure around a connector block in the vehicle according to a fifth embodiment.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

### First Embodiment

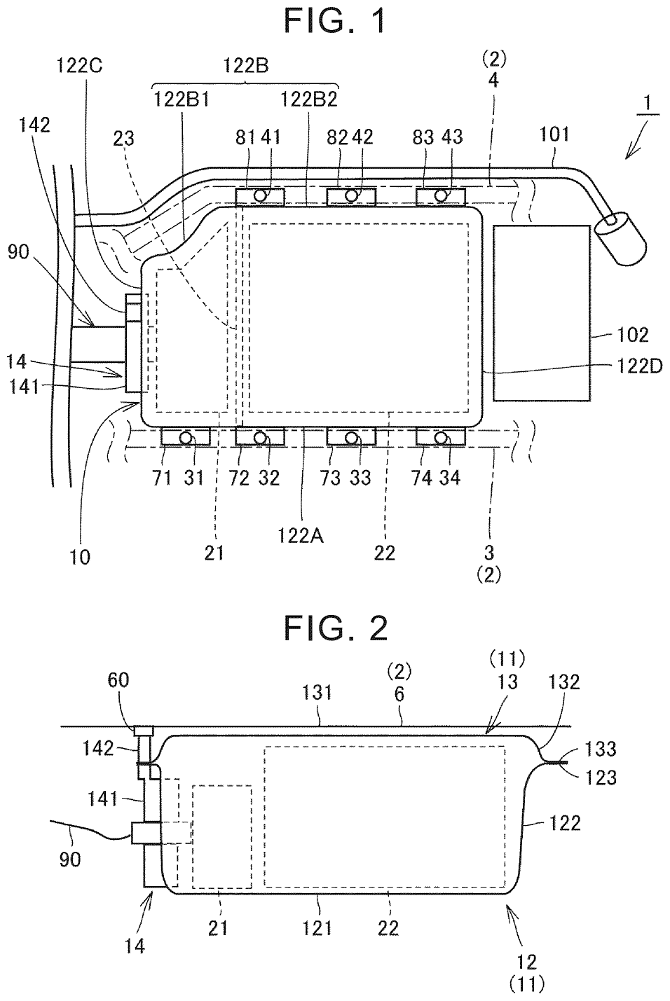

FIG. 1 is a plan view illustrating an energy storage device fixed to a vehicle frame member in a state adjacent to an exhaust pipe in a width direction of a vehicle in a vehicle according to a first embodiment. FIG. 2 is a side view of an energy storage device disposed below a floor panel in the vehicle according to the first embodiment. Referring to FIGS. 1 and 2, a vehicle 1 according to a first embodiment will be described.

In the present embodiment, the vehicle 1 is an example of a hybrid electric vehicle that can travel by using power of either or both of the motor and the engine. The vehicle 1 may be an electrified vehicle that travels with a driving force obtained by electric energy.

The vehicle 1 includes a vehicle body 2, an energy storage device 10, an exhaust pipe 101, a fuel tank 102, a vehicle wire harness 90, a plurality of first fastening portions 31 to 34 and a plurality of second fastening portions 41 to 43 as a plurality of fastening portions, and a cushioning member 60.

The vehicle body 2 includes a first member 3, a second member 4, and a floor panel 6. The first member 3 and the second member 4 are frame members that form the frame of the vehicle. The first member 3 and the second member 4 extend along the front-rear direction of the vehicle. The first member 3 and the second member 4 are spaced apart from each other in the width direction of the vehicle. The first member 3 is located on one side in the width direction of the vehicle, and the second member 4 is located on the other side in the width direction of the vehicle. When viewed from above, the second member 4 is disposed between the exhaust pipe 101 and the second sidewall 122B described later. The energy storage device 10 is fixed to the first member 3 and the second member 4.

an energy storage device 10, an exhaust pipe 101, and a fuel tank 102 are disposed below the floor panel 6. One end of the vehicle wire harness 90 connected to the energy storage device 10 is also routed below the floor panel 6.

The energy storage device 10 includes a housing case 11, an electric device 21, a power storage module 22, and a plurality of fixed portions 71 to 74, 81 to 83. The housing case 11 houses the electric device 21 and the power storage module 22 therein. The housing case 11 includes an upper member 13 and a lower case 12.

The upper member 13 has a box shape that opens downward. The upper member 13 includes a top plate portion 131, a peripheral wall 132, and a flange portion 133. The top plate portion 131 forms an upper wall of the housing case 11. The peripheral wall 132 extends downward from the peripheral edge of the top plate portion 131. The flange portion 133 extends from the lower end of the peripheral wall 132 to the outside of the housing case. The upper member 13 may have a lid shape in which the peripheral wall 132 is not provided.

The lower case 12 has a box shape that opens upward. The lower case 12 includes a bottom plate portion 121, a peripheral wall 122, and a flange portion 123. The bottom plate portion 121 faces the top plate portion 131 in the vertical direction. The vertical direction is parallel to the vertical direction of the vehicle. The peripheral wall 122 extends upward from the peripheral edge of the bottom plate portion 121. The flange portion 123 extends from the upper end of the peripheral wall 122 to the outside of the housing case.

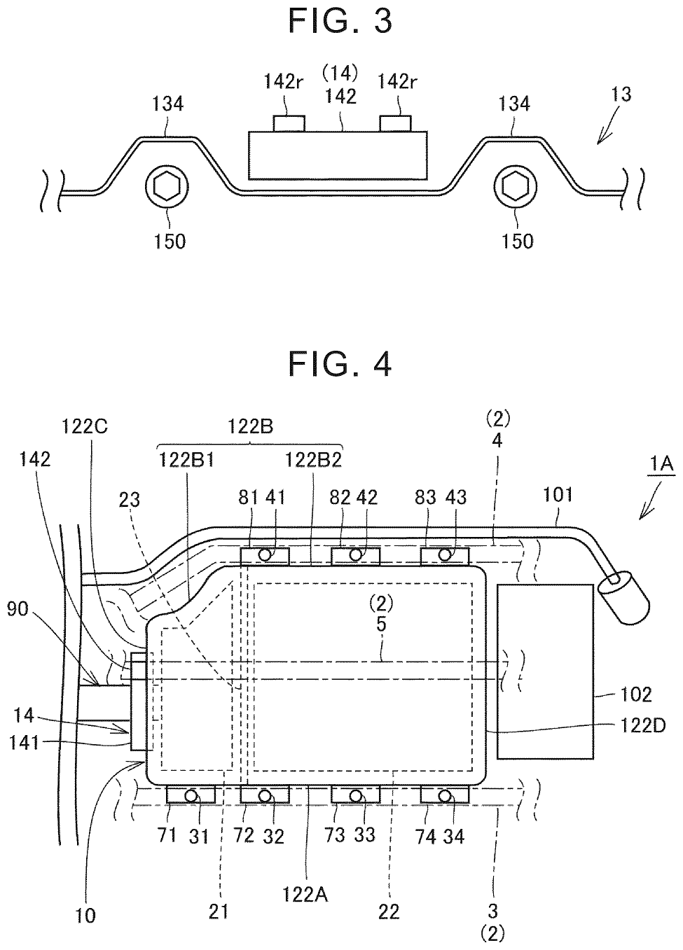

The flange portion 133 and the flange portion 123 are fastened by a plurality of fastening members 150 (see FIG. 3) in a state of being superimposed on each other in the up-down direction. Thus, the upper member 13 and the lower case 12 are integrally coupled to each other and form a space for accommodating the electric device 21 and the power storage module 22 therein.

The lower case 12 is provided with a partition member 23. The partition member 23 partitions a region in which the electric device 21 is disposed and a region in which the power storage module 22 is disposed. The partition member 23 connects, for example, the first sidewall 122A and the second sidewall 122B, which will be described later.

The electric device 21 is, for example, a junction box or the like. The power storage module 22 includes a plurality of power storage stacks. Each power storage stack is configured by arranging a plurality of power storage cells. The power storage cell is a secondary battery such as a nickel metal hydride battery or a lithium-ion battery. The electricity storage cell may be a liquid electrolyte or a solid electrolyte. The power storage cell may be a chargeable/dischargeable capacitor.

The peripheral wall 122 includes a first sidewall 122A, a second sidewall 122B, a front wall 122C, and a rear wall 122D. The first sidewall 122A and the second sidewall 122B are located spaced apart from each other in the width direction. The first sidewall 122A is located on one side in the width direction of the vehicle. The first sidewall 122A is substantially parallel to the front-rear direction of the vehicle.

A plurality of fixed portions 71 to 74 is provided at the first sidewall 122A. The plurality of fixed portions 71 to 74 is arranged at intervals in the front-rear direction of the vehicle. The plurality of fixed portions 71 to 74 is fixed to the first member 3 by fastening members such as bolts and nuts, and the plurality of first fastening portions 31 to 34 is formed at fastening positions of the respective fixed portions. That is, the plurality of first fastening portions 31 to 34 is portions where the energy storage device 10 is fixed to the first member 3. The plurality of fixed portions 71 to 74 is, for example, metal pieces.

The second sidewall 122B is located on the other side in the widthwise direction. The second sidewall 122B has a first portion 122B1 and a second portion 122B2. The first portion 122B1 is located on the front side of the second sidewall 122B. The first portion 122B1 extends more toward one side of the vehicle in the width direction as it gets closer to the front. The second portion 122B2 is located rearward of the first portion 122B1. The second portion 122B2 is substantially parallel to the front-rear direction of the vehicle. The distance between the first sidewall 122A and the second sidewall 122B on the front side is smaller than the distance between the first sidewall 122A and the second sidewall 122B on the rear side.

A plurality of fixed portions 81 to 83 is provided at the second sidewall 122B. The plurality of fixed portions 81 to 83 is arranged at intervals in the front-rear direction of the vehicle. The plurality of fixed portions 81 to 83 is disposed at the second portion 122B2 of the second sidewall 122B. Neither the fixed portions nor the second fastening portions are provided at the first portion 122B1. The plurality of fixed portions 81 to 83 is fixed to the second member 4 by fastening members such as bolts and nuts, and the plurality of second fastening portions 41 to 43 is formed at fastening positions of the respective fixed portions. That is, the plurality of second fastening portions 41 to 43 is portions where the energy storage device 10 is fixed to the second member 4. The plurality of fixed portions 81 to 83 is, for example, metal pieces.

The first fastening portion 31 located furthest to the front out of the plurality of first fastening portions 31 to 34 is located forward of the second fastening portion located furthest to the front out of the plurality of second fastening portions 41 to 44. The first fastening portion 32 and the second fastening portion 41 are located spaced apart from each other in the width direction of the vehicle. The first fastening portion 33 and the second fastening portion 42 are located spaced apart from each other in the width direction of the vehicle. The first fastening portion 34 and the second fastening portion 43 are located spaced apart from each other in the width direction of the vehicle.

The front wall 122C and the rear wall 122D are located spaced apart from each other in the front-rear direction. The front wall 122C connects the front ends of the first sidewall 122A and the second sidewall 122B to each other. The rear wall 122D connects the rear ends of the first sidewall 122A and the second sidewall 122B.

The front wall 122C is provided with a connector block 14. For example, the wire harness 90 etc. on the vehicle side is connected to the connector block 14. The connector block 14 is made of, for example, a metal member such as aluminum. The connector block 14 is a single-piece component made of the same material. Specifically, the connector block 14 is manufactured by die casting.

The connector block 14 includes a body portion 141 and a protruding portion 142 protruding upward from the body portion 141. The protruding portion 142 overlaps the floor panel 6 in the vertical direction. A cushioning member 60 is disposed between the upper end of the protruding portion 142 and the floor panel 6. For example, the cushioning member 60 is an elastic member made of rubber etc. The cushioning member 60 can reduce transmission of vibration etc. from the protruding portion 142 to the floor panel 6. Further, as will be described later, when an upward load is applied to the energy storage device 10, part of the external force transmitted to the floor panel 6 can be absorbed.

The present embodiment illustrates an example in which the cushioning member 60 is disposed. However, the cushioning member 60 may be omitted. In this case, the protruding portion 142 may be in contact with the floor panel 6. Further, as long as the protruding portion 142 hits the floor panel 6 by the upward load, clearance may be provided between the protruding portion 142 and the floor panel 6.

The exhaust pipe 101 extends in the front-rear direction of the vehicle. The exhaust pipe 101 is disposed adjacent to the second sidewall 122B in the width direction of the vehicle. Clearance is provided between the exhaust pipe 101 and the second sidewall 122B. The plurality of fixed portions 81 to 83 is located in the clearance. The exhaust pipe 101 includes, at its front, a portion that extends more toward one side in the widthwise direction as it gets closer to the front, and the portion extends along the first portion 122B1 described above.

The fuel tank 102 is disposed behind the rear wall 122D. Fuel such as gasoline is stored in the fuel tank 102. Fuel is supplied from the fuel tank 102 to an engine, not shown.

FIG. 3 is a plan view illustrating a position of a protruding portion in the vehicle according to the first embodiment. As shown in FIG. 3, the flange portion 133 includes a plurality of projecting portions 134 that projects forward. The plurality of projecting portions 134 is located spaced apart from each other in the width direction of the vehicle on the front side and the rear side of the vehicle, and is located spaced apart from each other in the front-rear direction of the vehicle on the side of the vehicle. FIG. 3 shows part of the flange portion 133 that is located on the front wall 122C side. The protruding portion 142 is disposed in the clearance between the projecting portions 134 adjacent to each other, as viewed from above. Providing the protruding portion 142 in this manner prevents the protruding portion 142 from being located forward of the flange portion 133, and reduces an increase in length of the energy storage device 10 in the front-rear direction of the vehicle. Further, the protruding portion 142 may be provided with a rib 142r along the protruding direction. As a result, the rigidity of the protruding portion 142 can be increased.

The first fastening portion 31 located furthest to the front out of the plurality of first fastening portions 31 to 34 disposed at the first sidewall 122A is typically located forward of the second fastening portion 41 located furthest to the front out of the plurality of second fastening portions 41 to 43 disposed at the second sidewall 122B. As a result, the energy storage device 10 tends to be deformed upward in the region forward of an imaginary line connecting the first fastening portion 31 located furthest to the front and the second fastening portion 41 located furthest to the front.

In the vehicle 1 according to the present embodiment, although the positional relation between the first fastening portion 31 and the second fastening portion 42 as described above, the protruding portion 142 provided at the front wall 122C while protruding upward is disposed so as to overlap a portion (specifically, the floor panel 6) of the vehicle body 2 in the vertical direction. Accordingly, when a load is applied upward to the energy storage device 10, the protruding portion 142 hits the vehicle body 2. This reduces upward deformation of the energy storage device 10 in the region forward of the second fastening portion 41 located furthest to the front. As a result, deformation of the floor panel 6 can also be suppressed.

### Second Embodiment

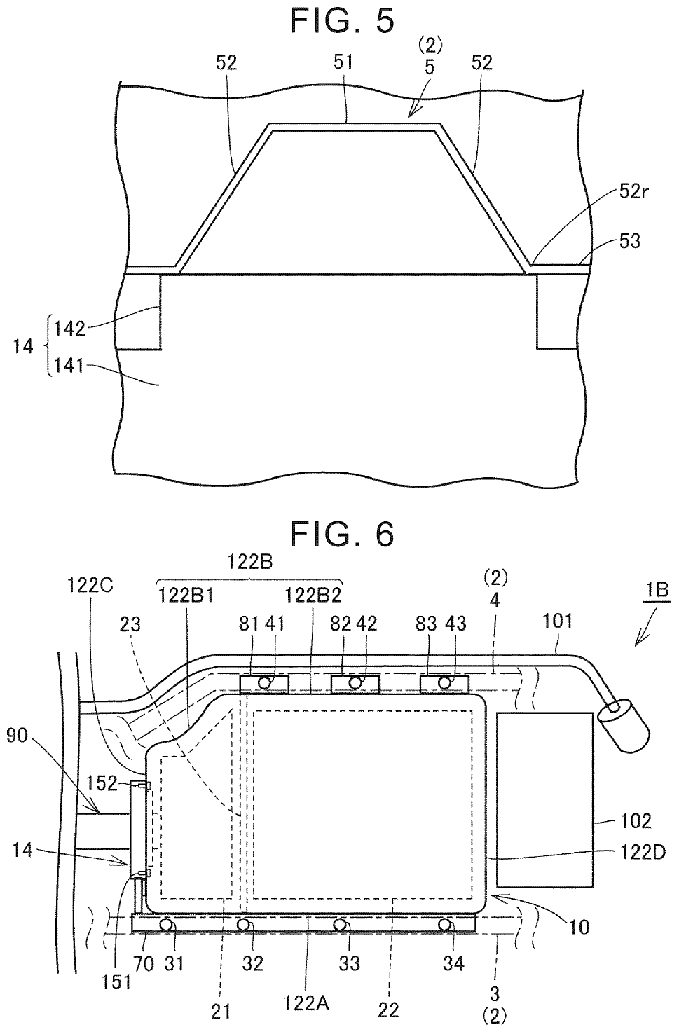

FIG. 4 is a plan view illustrating an energy storage device fixed to a vehicle frame member in a state adjacent to an exhaust pipe in a width direction of the vehicle in the vehicle according to a second embodiment. FIG. 5 is an enlarged view illustrating a structure around a third member in the vehicle according to the second embodiment. Referring to FIGS. 4 and 5, a vehicle 1A according to the second embodiment will be described.

The vehicle 1A according to the second embodiment differs from the vehicle according to the first embodiment in that a third member 5 is provided and the protruding portion 142 is provided so as to be able to hit the third member 5. The other configurations are substantially the same.

The third member 5 is a part of the frame member included in the vehicle body 2. The third member 5 is positioned above the upper member 13. The third member 5 extends along the front-rear direction of the vehicle. The third member 5 is disposed between the first member 3 and the second member 4 in the width direction of the vehicle. In the present embodiment, a case in which the third member 5 is located substantially at the center of the first member 3 and the second member 4 is exemplified, but the present disclosure is not limited thereto. The third member 5 may be located closer to the first member 3 or may be located closer to the second member 4 so long as it includes a portion located above the connector block 14.

A space is formed between the third member 5 and the upper member 13. Wires may be arranged in the space. The third member 5 has a ceiling portion 51, a pair of walls 52, and a flange portion 53.

The pair of walls 52 is spaced apart from each other in the width direction of the vehicle. The upper ends of the pair of walls 52 are connected to both ends of the ceiling portion 51 in the width direction of the vehicle. The flange portion 53 extends outward in the width direction of the vehicle from the lower ends of the pair of walls 52. The flange portion 53 is connected to root portions 52r of the pair of walls 52. Since the flange portion 53 of the third member 5 is bent at the root portions 52r, the root portions 52r have high rigidity.

In the present embodiment, the protruding portion 142 overlap the root portions 52r of the pair of walls 52 in the vertical direction. Therefore, when a load is applied to the energy storage device 10 from the lower side to the upper side, the protruding portion 142 hits the root portion 52r. This reduces deformation of the energy storage device 10 in the width direction in the region forward of the second fastening portion 41 located furthest to the front. As described above, since the root portions 52r have high rigidity, the above advantages can be remarkably exhibited. The cushioning member 60 may be disposed between the root portion 52r and the protruding portion 142.

As described above, in the vehicle 1A according to the second embodiment, substantially the same advantages as those of the vehicle 1 according to the first embodiment can be obtained.

### Third Embodiment

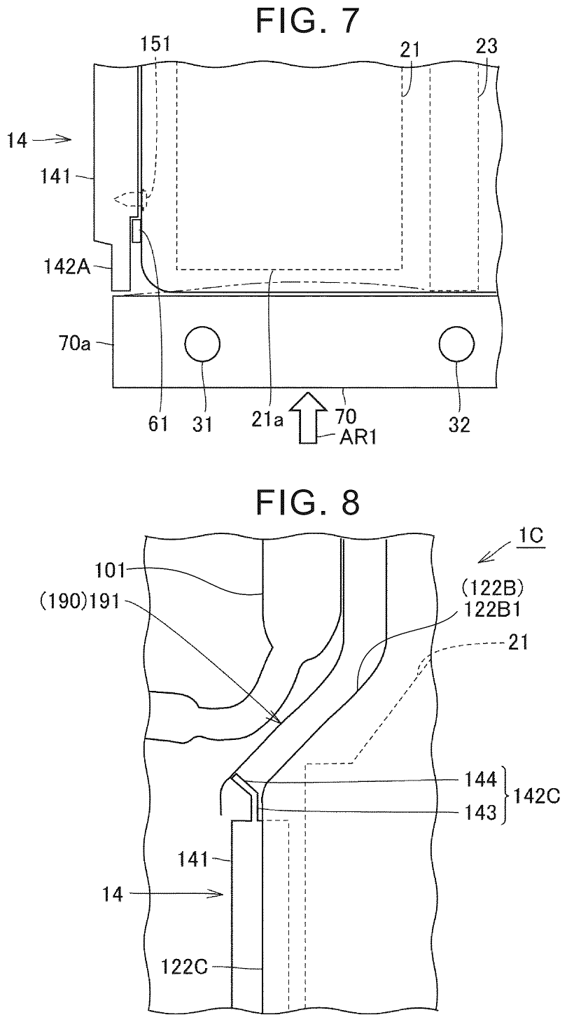

FIG. 6 is a plan view illustrating an energy storage device fixed to a vehicle frame member in a state adjacent to an exhaust pipe in a width direction of the vehicle in the vehicle according to a third embodiment. FIG. 7 is an enlarged view illustrating a structure around a protruding portion of a connector block in the vehicle according to the third embodiment. Referring to FIGS. 6 and 7, a vehicle 1B according to the third embodiment will be described.

The vehicle 1B according to the third embodiment differs from the vehicle 1 according to the first embodiment in the protruding portion 142A and a fixed portion 70. Other configurations are substantially the same.

The protruding portion 142A protrudes from the body portion 141 toward one side in the width direction. When viewed from above, the distal end of the protruding portion 142A is located on one side in the width direction with respect to the end 21a of the electric device 21 located on one side in the width direction.

The fixed portion 70 extends along the front-rear direction. The fixed portion 70 is provided with at least the first fastening portions 31, 32. In the present embodiment, a case where the first fastening portions 31 to 34 are provided in the fixed portion 70 is exemplified, but the present disclosure is not limited thereto. The position of the front end 70a of the fixed portion 70 is preferably substantially the same as the position of the front end of the protruding portion 142A in the front-rear direction. As a result, the fixed portion 70 can be shortened, and a decrease in strength and rigidity of the fixed portion 70 can be suppressed.

The connector block 14 is fastened and fixed to the front wall 122C by fastening members 151, 152. The fastening member 151 fixes an end of the body portion 141 located on one side of the vehicle in the widthwise direction to the front wall 122C. The fastening member 152 fixes an end of the body portion 141, which is located on the other side in the widthwise direction, to the front wall 122C.

Clearance is provided between the protruding portion 142A and the front wall 122C, and a cushioning member 61 is disposed in the clearance. The cushioning member 61 is an elastic member made of rubber etc. As a result, it is possible to suppress the sticking of the protruding portion 142A.

Here, the first fastening portion 31 located furthest to the front out of the plurality of first fastening portions 31 to 34 disposed at the first sidewall 122A is located forward of the second fastening portion 41 located furthest to the front out of the plurality of second fastening portions 41 to 43 disposed at the second sidewall 122B. As a result, in the width direction, there is no fastening portion on the opposite side of the first fastening portion 31 located furthest to the front. In such a case, when an external force is applied from the first sidewall 122A side toward the second sidewall 122B side, the energy storage device 10 tends to be deformed inward in the width direction (toward the other side in the width direction) at the first fastening portion 31 located furthest to the front.

In the vehicle 1 according to the present embodiment, although the positional relation between the first fastening portion 31 and the second fastening portion 42 as described above, the protruding portion 142A provided on the front wall 122C side while protruding toward the outer side in the width direction of the vehicle is disposed so as to overlap a portion of the fixed portion 70 in the width direction of the vehicle. Accordingly, when a load is applied from the fixed portion 70 side toward the second sidewall 122B side, the fixed portion 70 hits the protruding portion 142A. This can reduce deformation of the energy storage device 10A the width direction at the first fastening portion 31 located furthest to the front.

Further, in the present embodiment, the protruding portion 142A, the electric device 21, and the partition member 23 are arranged in this order in the front-rear direction. When an external force is applied in the direction of arrow AR1 in FIG. 7 due to a side collision etc., the protruding portion 142A and the partition member 23 are stretched, so that bending deformation of the fixed portion 70 and the first sidewall 122A can be reduced as indicated by a long dashed double-short dashed line in FIG. 7. Further, as described above, since the distal end of the protruding portion 142A is located outward of the end 21a of the electric device 21 in the widthwise direction, it is possible to prevent the deformed first sidewall 122A from colliding with the electric device 21. Thus, it is possible to suppress the damage of the electric device 21.

Further, an end of the body portion 141 located on one side in the width direction of the vehicle is fastened by the fastening member 151. Accordingly, when an external force is applied in the direction of arrow AR1 in FIG. 7, the load is also transmitted to the fastening member 151 via the protruding portion 142A that has hit the fixed portion 70. The load may be supported by shearing of the fastening member 151. The number of fastening members 151 is not limited to one, and a plurality of fastening members may be provided at the same position in the width direction. In this case, the strength can be increased by the plurality of fastening members 151.

In addition, by extending the fixed portion 70 in the front-rear direction, the fixed portion 70 can also function as a cushioning material.

### Fourth Embodiment

In general, a heater insulator is disposed between the sidewall of the energy storage device and the exhaust pipe. Clearance is provided between the heater insulator and the sidewall of the energy storage device. In the case where there is no measure, there is a concern that hot gas heated by the exhaust pipe through which hot gases pass enters the clearance and the temperature inside the energy storage device rises through the sidewall of the energy storage device.

The vehicle according to the present embodiment is configured for the purpose of suppressing an increase in temperature inside the energy storage device due to hot gas flowing outside.

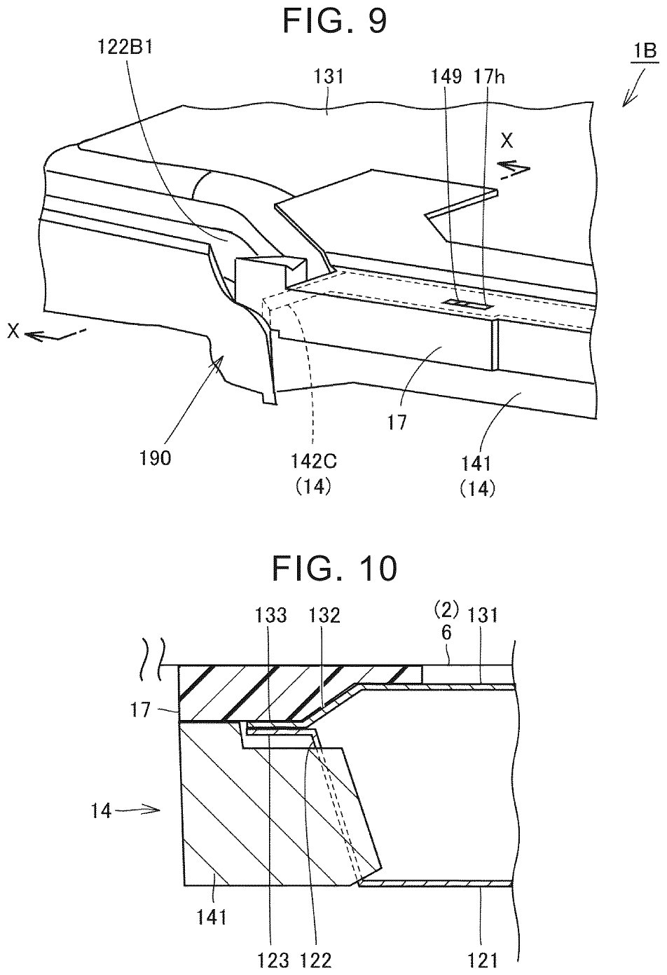

FIG. 8 is an enlarged plan view illustrating a structure around a connector block in the vehicle according to the fourth embodiment. FIG. 9 is a perspective view illustrating a structure around a connector block in the vehicle according to the fourth embodiment. FIG. 10 is a cross-sectional view taken along X-X shown in FIG. 9. Referring to FIGS. 8 to 10, a vehicle 1C according to the fourth embodiment will be described.

The vehicle 1C according to the fourth embodiment is different from the vehicle 1 according to the first embodiment in that it includes the heater insulator 190, that it includes the heat insulating member 17, and that the protruding portion 142 protrudes. The other configurations are substantially the same.

The heater insulator 190 is disposed between the second sidewall 122B and the exhaust pipe 101. The heater insulator 190 is provided along the second sidewall 122B. The front side of the heater insulator 190 is provided along the first portion 122B1. The heater insulator 190 is disposed away from the second sidewall 122B, and a space is formed between the heater insulator 190 and the second sidewall 122B.

The protruding portion 142C extends between the second sidewall 122B and the heater insulator 190. The protruding portion 142C includes a first extending portion 143 and a second extending portion 144. The first extending portion 143 extends outward in the width direction along the front wall 122C from an end of the body portion 141 located on the other side in the width direction of the vehicle. The second extending portion 144 extends from an end of the first extending portion 143 located on the other side in the width direction of the vehicle toward the heater insulator 190. The second extending portion 144 extends in a direction perpendicular to the extending direction of the first portion 122B1. The distal end of the second extending portion 144 may be in contact with the heater insulator 190 or may be slightly separated from the heater insulator 190. The protruding portion 142C reduces the flow of gas from the distal end of the heater insulator 190 into the space between the second sidewall 122B and the heater insulator 190.

The heat insulating member 17 covers the front side of the housing case 11. The heat insulating member 17 covers the top plate portion 131, the peripheral wall 132, and the flange portion 133 of the upper member 13 on the front side. The heat insulating member 17 is disposed between the floor panel 6 and the connector block 14 and the upper member 13. The heat insulating member 17 is preferably in contact with the floor panel 6. This reduces entry of the outside air heated by the exhaust pipe 101 through which hot gases flows into the space between the heat insulating member 17 and the floor panel 6.

The heat insulating member 17 is engaged with the connector block 14. Specifically, for example, a protrusion 149 of the connector block 14 is inserted into a through hole 17h provided in the heat insulating member 17. Incidentally, not limited to the engagement between the through hole 17h and the protrusion 149, the protrusion 149 may be inserted into a recess provided in the lower surface of the heat insulating member 17, or the heat insulating member 17 and the connector block 14 may be engaged by a labyrinth configuration.

As described above, in the vehicle 1C according to the present embodiment, the protruding portion 142C reduces the flow of gas from the distal end side of the heater insulator 190 into the space between the second sidewall 122B and the heater insulator 190. This reduces entry of hot gas heated by the exhaust pipe 101 into the space between the second sidewall 122B and the heater insulator 190, and thus, reduces an increase in temperature inside the energy storage device 10 through the second sidewall 122B.

### Fifth Embodiment

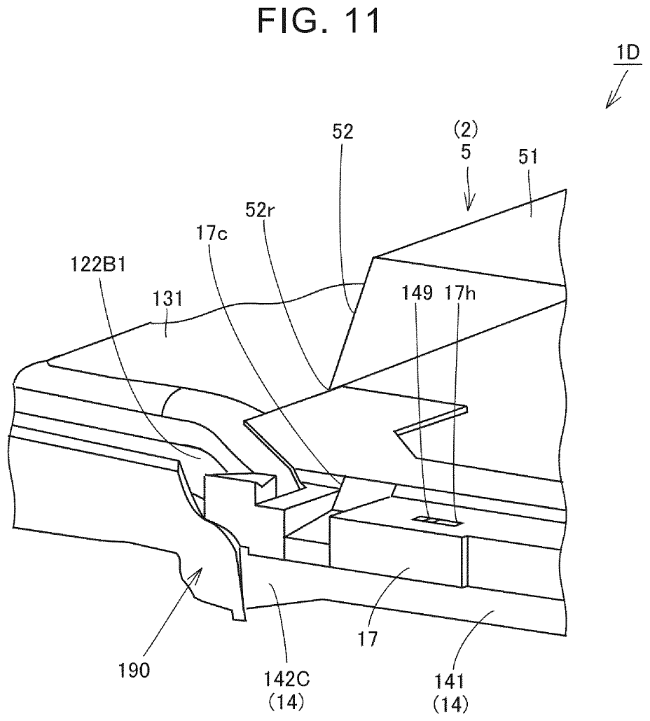

FIG. 11 is a perspective view illustrating a structure around a connector block in the vehicle according to a fifth embodiment. Referring to FIG. 11, a vehicle 1D according to the fifth embodiment will be described.

The vehicle 1D according to the fifth embodiment differs from the vehicle 1C according to the fourth embodiment in that the third member 5 is provided and the airflow guide portion 17c is provided in the heat insulating member 17. The other configurations are substantially the same. In the fifth embodiment, the heat insulating member 17 is not in contact with the floor panel 6.

The heat insulating member 17 is provided with a cut portion, and this cut portion serves as the airflow guide portion 17c. The airflow guide portion 17c guides the outside air heated in the exhaust pipe 101 into the space between the third member 5 and the upper member 13 on the front side of the energy storage device 10. The cut portion has a shape that is more tilted or curved as it gets closer to the rear.

Even with the above configuration, the vehicle 1D according to the fifth embodiment has substantially the same advantages as the vehicle 1C according to the fourth embodiment. Further, by providing the airflow guide portion 17c, it is possible to guide hot gas rearward through the inside of the third member 5.

In the first to third embodiments described above, a case in which the heater insulator 190 is omitted has been exemplified, but the heater insulator 190 may be provided as in the fourth and fifth embodiments.

The first to fifth embodiments illustrate the case in which the protruding portion is part of the connector block 14. However, the present disclosure is not limited to this, and the protruding portion may be provided as a separate member on the front wall 122C.

The embodiments disclosed herein are illustrative and not restrictive in all respects. The scope of the present disclosure is defined by the claims, and includes all modifications within the meaning and range equivalent to the claims.

What is claimed is:

1. A vehicle comprising:
a vehicle body including a floor panel and a frame member;
an energy storage device disposed below the floor panel; and
a plurality of fastening portions that fastens the energy storage device to the frame member, wherein:
the frame member includes a first member and a second member, the first member and the second member extending in a front-rear direction of the vehicle and being located spaced apart from each other in a width direction of the vehicle;
the energy storage device includes a first sidewall, a second sidewall, and a front wall, the first sidewall and the second sidewall being located spaced apart from each other in the width direction, and the front wall being located at a front of the energy storage device and connecting the first sidewall and the second sidewall;
the fastening portions include a plurality of first fastening portions located at the first sidewall and fixed to the first member, and a plurality of second fastening portions located at the second sidewall and fixed to the second member;
the first fastening portion located furthest to a front out of the first fastening portions is located forward of the second fastening portion located furthest to the front out of the second fastening portions;
a protruding portion protruding upward is provided at the front wall of the energy storage device; and
the protruding portion is disposed so as to overlap a portion of the vehicle body in a vertical direction.

2. A vehicle comprising:
a vehicle body including a floor panel and a frame member;
an energy storage device disposed below the floor panel; and
a plurality of fastening portions that fastens the energy storage device to the frame member, wherein:
the frame member includes a first member and a second member, the first member and the second member extending in a front-rear direction of the vehicle and being located spaced apart from each other in a width direction of the vehicle;
the energy storage device includes a first sidewall, a second sidewall, and a front wall, the first sidewall and the second sidewall being located spaced apart from each other in the width direction, and the front wall being located at a front of the energy storage device and connecting the first sidewall and the second sidewall;
the fastening portions include a plurality of first fastening portions located at the first sidewall and fixed to the first member, and a plurality of second fastening portions located at the second sidewall and fixed to the second member;
the first fastening portion located furthest to a front out of the first fastening portions is located forward of the second fastening portion located furthest to the front out of the second fastening portions;
the energy storage device further includes a fixed portion provided with at least the first fastening portion located furthest to the front out of the fastening portions;
a protruding portion protruding outward in the width direction is provided at the front wall of the energy storage device; and
the fixed portion extends in the front-rear direction and includes a portion overlapping the protruding portion in the width direction.

3. A vehicle comprising:
a vehicle body including a floor panel and a frame member;
an energy storage device disposed below the floor panel; and
a plurality of fastening portions that fastens the energy storage device to the frame member, wherein:
the frame member includes a first member and a second member, the first member and the second member extending in a front-rear direction of the vehicle and being located spaced apart from each other in a width direction of the vehicle;
the energy storage device includes a first sidewall, a second sidewall, and a front wall, the first sidewall and the second sidewall being located spaced apart from each other in the width direction, and the front wall being located at a front of the energy storage device and connecting the first sidewall and the second sidewall;
the fastening portions include a plurality of first fastening portions located at the first sidewall and fixed to the first member, and a plurality of second fastening portions located at the second sidewall and fixed to the second member;
the first fastening portion located furthest to a front out of the first fastening portions is located forward of the second fastening portion located furthest to the front out of the second fastening portions;
the vehicle further includes:
an exhaust pipe disposed along the second sidewall; and
a heater insulator disposed between the exhaust pipe and the second sidewall; and
a protruding portion is provided at the front wall of the energy storage device, the protruding portion extending between the second sidewall and the heater insulator, and the protruding portion being configured to reduce flow of gas from a distal end side of the heater insulator into a space between the second sidewall and the heater insulator.

4. The vehicle according to claim 1, wherein:
the energy storage device includes a connector block provided on the front wall;
the connector block is a single-piece component made of the same material; and
the protruding portion is part of the connector block.

5. The vehicle according to claim 1, wherein the protruding portion is provided with a rib.

6. The vehicle according to claim 1, further comprising a cushioning member disposed between the portion of the vehicle body and the protruding portion.
